(19) United States
(12) Patent Application Publication
(10) Pub. No.: US 2009/0008103 A1
(43) Pub. Date: Jan. 8, 2009

(54) Rapid deployment fire retardent gel pack

(76) Inventor: Peter Cordani, Palm Beach Gardens, FL (US)

Correspondence Address: MCHALE & SLAVIN, P.A., 2855 PGA BLVD, PALM BEACH GARDENS, FL, 33410, US

(21) Appl. No.: 12/208,832

(22) Filed: Sep. 11, 2008

Related U.S. Application Data
(63) Continuation-in-part of application No. 11/680,803, filed on Mar. 1, 2007.
(60) Provisional application No. 60/778,202, filed on Mar. 2, 2006.

(51) Int. Cl. A62C 39/00; B65D 35/44

(52) U.S. Cl. 169/30; 222/92

(57) ABSTRACT

The instant invention relates to a super absorbent polymeric material which when added to water produces a gel that enhances the fire extinguishing properties of the water. A pre-measured quantity of the polymeric gel material is packaged in a small easily opened dispenser type container. The disposable container is readily accessible for easy and rapid use of the gel by the individual under exigent circumstances to mitigate the effects of a rapid rise of temperature within a burning vehicle. The use of the gel providing sufficient time for the vehicle to leave the hostile zone prior to the individual exiting the vehicle. The gel provides extinguishing properties and is capable of long term storage.

### CROSS REFERENCE TO RELATED APPLICATIONS

This application is a continuation-in-part of application Ser. No. 11/680,803, filed Mar. 1, 2007, entitled Improvement to Water Based Fire Extinguishers which in turn claims the benefit of U.S. Provisional Application No. 60/778,202, entitled “Process for Fire Prevention and Extinguishing” filed on Mar. 2, 2006 the entire disclosure of which is herein incorporated by reference.

### FIELD OF THE INVENTION

This invention relates to a fire suppressant gel and disposable quick release dispenser. The gel is rapidly dispensed and applied to the skin, particularly around the face, to enable the individual to withstand the fire and heat when trapped in a confined space that is engulfed in flames. The gel is formed from a super absorbent polymer that is premixed with water in an amount sufficient to extinguish the flames and hydrate the exposed skin surface.

### BACKGROUND OF THE INVENTION

Water has been known for its fire retardant and extinguishing properties for millennia and remains the predominate material used to extinguish or prevent certain types of fires. Water has a high heat capacity and high heat of vaporization, such that when water is sprayed onto a fire, the water that reaches the flames absorbs the heat of the fire and cools the article to below its combustion temperature. Water also deprives the fire of oxygen. Often the heat of the fire turns a portion of water into vapor before it can reach the flames. Since water vapor is heavier than air it displaces the oxygen surrounding the fire, thereby suffocating the fire.

Today's modern soldier is often subject to attack while on maneuvers in either friendly or hostile territory. Vehicles such as armored personal carries, tanks, trucks, etc. are susceptible to attack by fire bombs, also known as Molotov cocktails, air propelled grenades, APGs, improvised explosive devices, IEDs, etc.

As the flames surround the vehicle, the tires and other combustible materials of the vehicle will reach an auto ignition temperature, approximately 350° Centigrade, thereby increasing the duration and intensity of the fire.

Once the tires and other combustibles are engulfed in flames the temperature of the fire surrounding the vehicle will exceed 1,200° C. and cause the temperature of the vehicle's interior is rise almost instantly and dramatically to several hundred degrees. At this point in time the damaged vehicles are generally functional and are capable of moving under their own power.

It is a natural response for the soldier trapped in a burning vehicle to exit the vehicle and escape the fire and noxious gas as quickly as possible, if not immediately. It has been noted, that in particular, the rapid rise in temperature around the persons face causes an instinctive desire to flee the source of the heat. The sensitivity is most notable in the areas of the nose and ears.

It would be very ill advised to stop the vehicle and escape the burning vehicle while still within the range of the combatant's weapons, notwithstanding the inferno surrounding the vehicle. The escaping soldiers would be easy targets for small arms fire, grenades, IEDs and the like.

There is therefore a need to provide the personal with a device which will enable them to withstand the heat of the fire for a limited amount of time to facilitate their extraction from the hostile zone.

U.S. Pat. No. 5,989,446 discloses a water additive for use in fire extinguishing and prevention. The additive comprises a cross-linked water-swellable polymer in a water/oil emulsion that is produced by an inverse phase polymerization reaction. The polymer particles are dispersed in an oil emulsion wherein the polymer particles are contained within discrete water “droplets” within the oil. With the help of an emulsifier, the water “droplets” are dispersed relatively evenly throughout the water/oil emulsion. This allows the additive to be introduced to the water supply in a liquid form, such that it can be easily educted with standard firefighting equipment. However, it has been observed that when this additive is placed in fire extinguishers which utilize a container of water, the mixture requires agitation every 15 days to prevent the polymer from settling out. Another problem with this additive is that it takes approximately 3-4 hours to “cure” such that it is able to absorb a sufficient amount of water and attain the viscosity necessary to adhere to vertical and horizontal surfaces for firefight purposes. Also, if the additive/water mixture is not completely flushed from a hose or nozzle after use, it will harden upon drying out and render the hose or nozzle useless.

U.S. Pat. No. 7,169,843 discloses absorptive, cross-linked polymers which are based on partly neutralized, monoethylenically unsaturated monomers carrying acid groups, and with improved properties, which has a high gel bed permeability and high centrifuge retention capacity.

U.S. Pat. No. 5,989,446 discloses prevention of the spread of fires and directly fighting fires, a cross-linked, water-swellable additive polymer in water/oil emulsion to be added to the firefighting water. The additive has the properties of absorbing large quantities of water, high viscosity for adherence to vertical and horizontal surfaces, and retention of sufficient fluidity. The method of adding this additive to the firefighting water by eduction or by a batch addition to the water source is also disclosed.

U.S. Pat. No. 5,190,110 discloses the fighting of fires or protection of objects from fire by applying thereto water, which comprises dispersing in the water particles of a cross-linked, water-insoluble but highly water-swellable acrylic acid derivative polymer in an amount insufficient to bring the viscosity above 100 mPa's. Advantageously, the particles are present in an amount such that after swelling the swollen particles hold 60 to 70% by weight of the total water, the polymer being a copolymer of an acrylic acid, the water containing silicic acid and/or a silicate as well as sodium, potassium or ammonium ions. The water is freely pumpable but the swollen particles adhere to surfaces they contact rather than running off rapidly.

U.S. Pat. No. 5,849,210 discloses a method of preventing or retarding a combustible object from burning including the steps of mixing water with a superabsorbent polymer (“SAP”) to form one at least partially hydrated SAP, and applying the at least partially hydrated SAP to the combustible object, before or after combustion. In another embodiment, an article of manufacture includes a SAP, that is prehydrated, is useful for preventing a combustible object from burning, or preventing penetration of extreme heat or fire to a firefighter or other animal.

U.S. Pat. No. 6,372,842 discloses methods of using an aqueous composition or dispersion containing a water-soluble or water-dispersible synthetic polymer, and compositions formed thereof. The aqueous composition or dispersion is added to agricultural spray, ink, deicing, latex paint, cleaner and fire-extinguishing chemical compositions, water-based hydraulic compositions, dust control compositions and so on, to impart properties including, but not limited to, aerosol control, shear stability, transfer efficiency, oil/water reduction, emollient performance, lubricity, thickening, and anti-wear capability, to the resultant composition formed thereof.

U.S. Pat. No. 5,087,513 discloses polybenzimidazole polymer/superabsorbent polymer articles. These articles are prepared by either mixing the superabsorbent polymer particulates with the polybenzimidazole polymer solution during the formation of the polybenzimidazole article, or forming a composite of a polybenzimidazole film or fiber material layer with a superabsorbent polymer particulate containing layer. These polybenzimidazole products absorb large amounts of fluid while retaining the flame retardancy and chemical unreactivity of conventional polybenzimidazole materials.

U.S. Pat. No. 4,978,460 discloses a particulate additive for water for fire fighting containing a strongly swelling water-insoluble high molecular weight polymer as gelatinizing agent, which comprises a water-soluble release agent which causes the particles of said gelatinizing agent not to swell, the particles of the gelatinizing agent being encased or dispersed in the release agent. Suitable release agents include polyethylene glycol, sugars, mannitol, etc. The gelatinizing agent may be a moderately cross-linked water-insoluble acrylic or methacrylic acid copolymer.

U.S. Pat. No. 5,519,088 discloses an aqueous gel comprising a polymer of (meth)acrylamide or particular (meth)acrylamide derivative(s), particulate metal oxide(s) and an aqueous medium, a process for producing said gel, and products utilizing said gel. This aqueous gel can be produced so as to have transparency, has fire resistance and can prevent the spreading of flames, and is highly elastic. The aqueous gel when produced transparent, becomes cloudy when heated or cooled and is useful for the shielding of heat rays or cold radiation.

Thus, what is lacking in the art is a device that will enable a person trapped within a burning vehicle to withstand the heat of a fire for a time sufficient to enable the vehicle to drive out of the hostile zone. A device that is easily carried, and easily and quickly deployed by a soldier who is under attack and trapped in a burning vehicle.

### SUMMARY OF THE INVENTION

The instant invention discloses a fire retarding gel and a rapid deployment dispensing device for protecting an individual's skin. The gel formed from a superabsorbent polymer in water protects the skin by retarding or extinguishing fire. The reaction of the water with the polymer creates a gel-like substance with a viscosity that allows the mixture to cover vertical and horizontal surfaces and to act as barrier to prevent fire from damaging the skin.

The super absorbent polymer is capable of absorbing water up to several thousands times its own weight. These super absorbent polymers are prepared from water-soluble polymers, but have cross-linking structures that render the polymers water-insoluble. By taking water-soluble ethylenically unsaturated monomers which readily undergo vinyl polymerization, such as acrylamide, with cross-linking agents, a polymer can be produced that is of uniform small size, has a high gel capacity, is highly insoluble, but highly water-swellable (i.e., super absorbent polymer). The gel capacity refers to the property of the water-swollen polymer to resist viscosity changes as a result of mechanical working or milling.

The super absorbent polymers can be dehydrated to a powder. When the powder is added to an aqueous solution and agitated, a super absorbent gel-like substance is formed. In a dry state the preferred polymer may be considered a particle having a diameter less than 4000 microns but greater than 50 microns. In a swollen state the particle may have a diameter greater than three hundred times its weight (more surface area). In a totally water-swollen state, the particles contain up to 99.98 weight percent of water and as little as about 0.1 weight percent of polymer. Thus, such particles could hold from ten to thousands of times their own weight.

Without being bound by any particular theory of operation it is believed that the since the polymer particles are capable of absorbing water in significant quantities relative to its own weight, the water-swollen gel provides a greater water laden surface area, with a higher heat capacity, than the unbound water molecule.

Once the polymer has been mixed with the water it remains in a gel like suspension and does not separate from the water for extended periods of time, i.e. years.

Accordingly, it is an objective of this invention to provide a super absorbent polymeric material which when added to water produces a gel that enhances the fire extinguishing properties of the water.

Another objective of the instant invention is to provide a disposable container that is readily accessible for easy and rapid use of the gel by the individual under exigent circumstances to mitigate the effects of a rapid rise of temperature within a burning vehicle

Yet another objective of the instant invention is to provide a composition to fight fires that is non-toxic, biodegradable and non-hazardous.

A further objective of the invention is to provide a composition to fight fires that will remain in solution, subsequently to being mixed with water, for an extended period of time.

Still another objective of the instant invention is to teach pre-treating people to prevent their skin from reaching an ignition temperature.

Yet another objective of the present invention is to teach a hydrated super absorbent polymer gel having a viscosity that allows the gel to be dispensed from a container reservoir without blocking the dispenser outlet.

Another objective of the instant invention is to teach a combination of water and super absorbent polymer having sufficient viscosity to enable it to cover and adhere to vertical and horizontal surfaces.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE DRAWINGS

FIG. 1 is a perspective view a disposable pouch type package container with a tear strip to provide rapid access to the packet's contents.

FIG. 2 is a perspective view of a disposable tube type dispenser with a frangible opening.

FIG. 3 is a perspective view of a disposable tube type dispenser with a threaded closure.

FIG. 4 is a perspective view of a disposal tube type dispenser with a hinged closure

FIG. 5 is a perspective view of a disposable tube with a self puncturing outlet closure element located in the outlet of the dispenser.

### DETAILED DESCRIPTION

Detailed embodiments of the instant invention are disclosed herein, however, it is to be understood that the disclosed embodiments are merely exemplary of the invention, which may be embodied in various forms.

Therefore, specific functional and structural details disclosed herein are not to be interpreted as limiting, but merely as a basis for the claims and as a representative basis for teaching one skilled in the art to various employ the present invention in virtually any appropriately detailed structure.

The present invention relates to a composition for and process of retarding or extinguishing conflagrations using a super absorbent polymer in water in an amount sufficient to retard or extinguish the fire. The present invention utilizes biodegradable super absorbent aqueous based polymers, for example, cross-linked modified polyacrylamides/potassium acrylate or polyacrylamides/ sodium acrylate commercially available from Stockhausen, Inc. (Greenboro, N.C.). Other suitable polymers include, albeit not limited to, carboxy-methylcellulose, alginic acid, cross-linked starches, and cross-linked polyaminoacids.

Referring now to the FIG. 1 wherein like elements are numbered consistently throughout, 10 illustrates a disposable dispenser formed of thin pliable material and sealed about its periphery to contain a pre mixed gel of the superabsorbent polymer and water. The dispenser is formed from single or multiple layers of either a flexible metal foil and/or polymeric sheet material which is compatible with the fire resistant gel.

The dispenser 10 is configured and sized to provide sufficient gel to cover one's face and in particular the ears and nose. To provide the necessary coverage the dispenser will contain from one to sixteen ounces of gel. The width of the dispenser package is relatively small, preferably less than one inch. The dispenser package can vary in width and length dependent upon the amount of gel contained therein and the manner in which the package is stowed and carried on one's person. While illustrated as rectangular in FIG. 1 is should be noted that that package could be square, or circular or any other geometric shape. The fire retardant material is created by mixing the SAP with water thereby forming a gel. The amount of powered super absorbent polymer used is in the range of about 0.88-1.48 ounces to 1 gallon of water and preferably 1.2 ounces to 1 gallon of water. The gel is then filled and sealed within each dispenser. The polymer can be added during the manufacturing process, prior to the dispenser being shipped to the user.

The dispenser 10 also includes a tear strip 12 located at one end of the package. The tear strip 12 includes a recess 14 at each end of the tear strip to facilitate the tearing process. Optionally, a second tear strip 16 can be located at the opposite end of the dispenser to improve the ease of opening in an emergency situation. The second tear strip 16 is similar in construction to first tear strip 12. Having recesses on both sides of the dispenser and tear strips at both ends eliminates the necessity of orienting the dispenser prior to pulling on the tear strip thereby saving invaluable seconds.

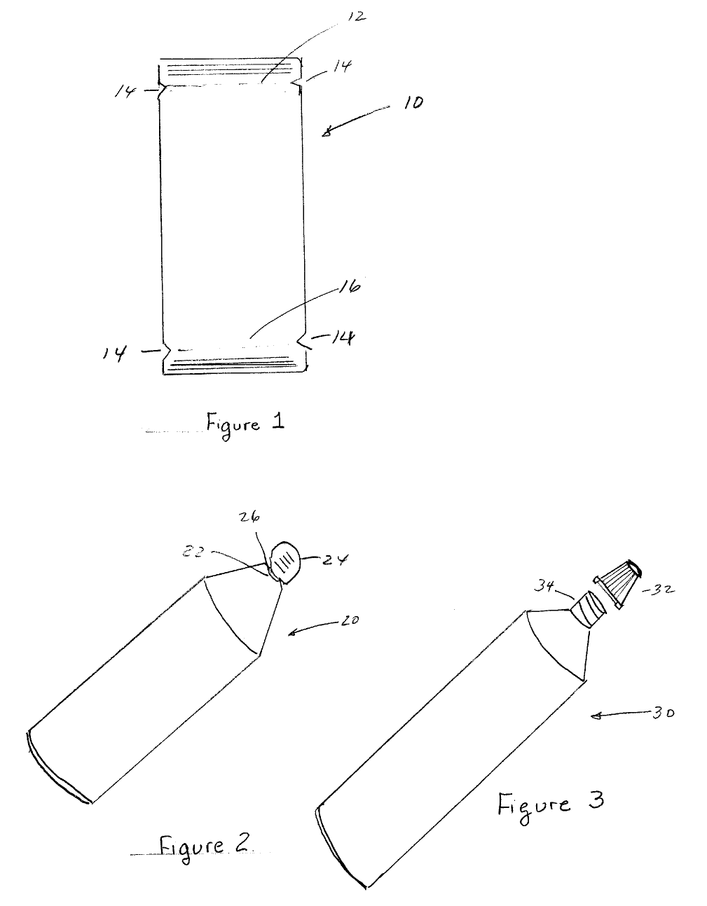

FIG. 2 illustrates an alternative dispenser 20. Dispenser 20 is a generally cylindrical member, or tube, formed from single or multiple layers of either a flexible metal foil and/or polymeric sheet material which is compatible with the fire resistant gel. One end of the generally cylindrical member is an outlet 22. Outlet 22 includes an integrally formed closure element 24. Outlet 22 and closure 24 are joined by a frangible connection 26. In use, the individual would simply break off the closure 24 from outlet 22 to allow the gel to flow through outlet 22 when pressure is applied to the external walls of the generally cylindrical member, or tube.

FIG. 3 is a perspective view of a disposable tube type dispenser 30 with a threaded closure. Dispenser 30 includes an externally threaded outlet 34 configured to mate with the internal threads of closure member 32. In use, the individual would simply unscrew the closure member 32 from the outlet 34 to allow the gel to flow through the outlet 34 when pressure is applied to the external walls of the generally cylindrical member or tube.

FIG. 3 is a perspective view of a disposable tube type dispenser 30 with a threaded closure. Dispenser 30 includes an externally threaded outlet 34 configured to mate with the internal threads of closure member 32. In use, the individual would simply unscrew the closure member 32 from the outlet 34 to allow the gel to flow through the outlet 34 when pressure is applied to the external walls of the generally cylindrical member or tube.

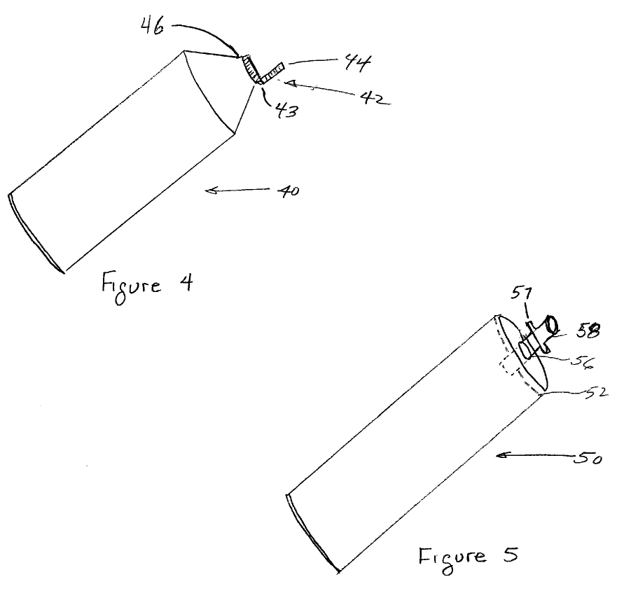

FIG. 4 is a perspective view of a disposable tube type dispenser 40 with a hinged closure. Dispenser 40 includes an outlet 44. A closure element 42 includes a cover 48 a pivot member 43 and a mounting element 46 affixed to outlet 44. In operation, closure element 46 is pivotally moveable between an open and closed position. In use, the individual would simply pivot the cover member 48 from the outlet 44 to allow the gel to flow through the outlet 44 when pressure is applied to the external walls of the generally cylindrical member, or tube.

FIG. 5 is a perspective view of a disposable tube type dispenser 50 with a self puncturing outlet closure element. A closure element 52 is comprised of a ruptureable membrane of metal foil or polymeric layer attached to the interior walls of the dispenser 50 and serves to block the outlet 56 and contain the polymeric gel within the disposable container 50. An outlet tube 58 is slidably retained in dispenser 50 and will rupture membrane 52 when pushed downwardly into the tube 50. A flange 57 on outlet tube 58 will allow the outlet tube to penetrate the membrane 58 but will limit its downward motion to prevent it from passing into the dispenser 50. In operation, outlet tube 58 is forced into dispenser thereby rupturing the membrane 52. Thereafter the gel will flow through the outlet 58 when pressure is applied to the external walls of the generally cylindrical member or tube.

When deployed in the field the following is presented as one possible manner in which the fire retardant gel and quick acting dispenser may be utilized. A patrol riding in an urban environment suddenly finds itself engaged with an enemy combatant. Without warning the vehicle is struck by a fire bomb and the vehicle is quickly engulfed in flames. Within seconds of the initial attack two of the tires catch on fire and increase the intensity of the inferno. The temperature within the vehicle rises several hundred degrees within just a few seconds. The soldier's instinct is to get out of the vehicle as the temperature about their face move them to flee the vehicle. Unfortunately to do so would make them easy targets for the insurgents. Instead the soldiers quickly grab the readily accessible dispenser of fire retardant gel and wipe it about their face and in particular their nose and ears. The gel buys the crew a little more time and within just those few extra seconds the vehicle is able to move away from the zone of hostility and out of harms way before abandoning their vehicle.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and drawings/figures.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention. Although the invention has been described in connection with specific preferred embodiments, it should be understood that the invention should not be unduly limited to such specific embodiments.

What is claimed is:

1. A dispenser containing a fire retardant gel wherein said fire retardant gel is comprised of a super absorbent polymeric material mixed with water and said dispenser is a container having flexible walls and a quick and easily opened closure element adjacent an outlet of the container, whereby pressure exerted on an outer surface of the container walls forces the gel through the outlet when said closure element is opened.

2. The dispenser containing a fire retardant gel of claim 1, wherein said dispenser is sized to hold a predetermined amount of fire retardant gel.

3. The dispenser containing a fire retardant gel of claim 1, wherein said gel is formed by mixing 0.88 to 1.48 ounces of super absorbent polymer to each gallon of water utilized.

4. The dispenser containing a fire retardant gel of claim 3 wherein said gel is formed by mixing about one ounce of superabsorbent polymer to each gallon of water utilized.

5. The dispenser containing a fire retardant gel of claim 3 wherein said super absorbent polymer is selected from the group consisting of cross-linked modified polyacrylamides, potassium acrylate, polyacrylamides, sodium acrylate carboxy-methylcellulose, alginic acid, cross-linked starches and cross-linked polyaminoacids.

6. The dispenser containing a fire retardant gel of claim 5, wherein said polymer is a cross-linked modified polyacrylamides/potassium acrylate.

7. The dispenser containing a fire retardant gel of claim 5, wherein said polymer is a cross-linked modified polyacrylamides/sodium acrylate.

8. The dispenser containing a fire retardant gel of claim 1 wherein said container is a disposable single use container.

9. The dispenser containing a fire retardant gel of claim 8 wherein said dispenser includes at least one tear strip to open said container.

10. The dispenser containing a fire retardant gel of claim 9 wherein said dispenser includes a second tear strip located on an opposite end of said dispenser.

11. The dispenser containing a fire retardant gel of claim 8 wherein said closure element is a connected to the outlet by a frangible member.

12. The dispenser containing a fire retardant gel of claim 8 wherein said closure element includes internal threads that are sized and configured to engage threads formed on an exterior surface of the outlet, whereby the closure element can be removed by unthreading it from the outlet.

13. The dispenser containing a fire retardant gel of claim 8 wherein said closure element includes and hinge and an outlet mounting element whereby the closure can be pivoted from a closed to an open position.

14. The dispenser containing fire retardant gel of claim 8 wherein said closure element is a ruptureable membrane, said dispenser further including an outlet tube that is slidably retained in the outlet of said dispenser, said outlet tube will rupture said membrane when pushed downwardly into said dispenser, said outlet tube including a flange on the exterior surface of the outlet tube that will allow the outlet tube to penetrate the membrane but will limit its downward motion to prevent it from passing into the dispenser.
